(19) United States
(12) Patent Application Publication
(10) Pub. No.: US 2025/0250427 A1
(43) Pub. Date: Aug. 7, 2025

(54) ARTICLE, CROSSLINKED THERMOPLASTIC ELASTOMER COMPOSITION, AND PRODUCING METHOD THEREOF

(71) Applicant: MCPP Innovation LLC, Tokyo (JP)

(72) Inventor: Yoshio KOBU, Tokyo (JP)

(73) Assignee: MCPP Innovation LLC, Tokyo (JP)

(21) Appl. No.: 19/063,020

(22) Filed: Feb. 25, 2025

Related U.S. Application Data
(63) Continuation of application No. PCT/JP2023/031788, filed on Aug. 31, 2023.

(30) Foreign Application Priority Data
Sep. 2, 2022 (JP) 2022-140092

(51) Int. Cl. C08L 23/10; B05D 1/14; B05D 5/10; B29C 35/02; B29C 48/15; B29C 48/21; B29C 48/36; B29K 23/00; B29K 101/12; B29K 105/24; B29L 31/30; C08J 3/24; C08J 7/043

(52) U.S. Cl. CPC C08L 23/10; B05D 1/14; B05D 5/10; B29C 35/02; B29C 48/15; B29C 48/21; B29C 48/36; C08J 3/247; C08J 7/043; B05D 2503/00; B29K 2023/10; B29K 2101/12; B29K 2105/24; B29K 2995/0012; B29L 2031/3002; C08L 2312/00

(57) ABSTRACT

An article having a plurality of seal lip parts, wherein at least one of the seal lip parts comprises a thermoplastic elastomer composition comprising a thermoplastic elastomer and a polyolefin having a repeating unit represented by the following formula (I):

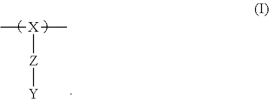

### CROSS-REFERENCE TO RELATED APPLICATIONS

The present application is a continuation of International Patent Application PCT/JP2023/031788 filed Aug. 31, 2023, which is based on and claims the benefit of priority to Japanese Application No. 2022-140092 filed Sep. 2, 2022. The entire contents of these applications are incorporated herein by reference.

### TECHNICAL FIELD

The present invention relates to an article suitable for use as a sealing member for automobile seal parts and the like. The present invention also relates to a crosslinked thermoplastic elastomer composition suitable as a material for the fiber-flocked seal lip part of the article, and a producing method thereof.

### BACKGROUND ART

Conventionally, adhesives have been used to bond thermoplastic resins to adherends such as different resins, paint, metal, and glass.

As an example of a case where adhesion between such different materials is required, there is a flocked synthetic resin molded body, that is, a synthetic resin molded body having pile flocked on the surface via an adhesive layer. A representative example of such a synthetic resin molded body is an automobile weather strip that is attached to automobile windows (around the window glass opening of the door) as a sealing material to prevent the intrusion of drafts, rain and the like, and to remove dirt from the glass by rubbing with the pile as the glass is raised and lowered. The weather strip is installed so that the pile is located on the side that comes into contact with the window glass.

Conventionally, such synthetic resin molded bodies have been produced by electrostatically flocking pile fibers of nylon short fibers or the like on a molded body made of an olefin-based polymer or a resin-coated metal via an adhesive layer.

For example, technology for introducing a functional group into a thermoplastic resin is used for such an adhesive layer.

For example, a maleic anhydride-modified polyolefin, in which an olefin-based polymer is modified with maleic anhydride to improve adhesion to an adherend and adhesive, is known (see Patent Literature 1).

In addition, a modified polyester-based thermoplastic elastomer, which is obtained by modifying a polyester-based thermoplastic elastomer obtained by copolymerizing polyester with polytetramethylene ether glycol with maleic anhydride, is known (see Patent Literature 2).

### CITATION LIST

### Patent Literature

[Patent Literature 1] JPH 9-278956 A
[Patent Literature 2] JP 2002-155135 A

### SUMMARY OF INVENTION

### Technical Problem

As the needs for products and parts that combine not only different resins but also paint, metal, glass, and the like with thermoplastic resins, such as the synthetic resin molded body mentioned above, become more diverse, there is a demand for improved adhesive strength between the adherend and the thermoplastic resin. In addition, from the viewpoints of reducing equipment costs and maintenance costs, reducing environmental load, and reducing processes, there is a demand for sufficient adhesive strength without the need for a corona treatment or a primer treatment.

However, it was found that the modified polyolefins and modified polyester elastomers described in Patent Literatures 1 and 2 had room for improvement in terms of adhesive strength.

An object of the present invention is to provide an article having excellent adhesion and excellent flocking durability of flocked fibers, using a thermoplastic elastomer composition having excellent adhesion to adhesive, different resins, paint, metal, or glass.

Another object of the present invention is to provide a crosslinked thermoplastic elastomer composition suitable as a constituent material for the fiber-flocked seal lip part of such an article.

### Solution to Problem

The inventors of the present invention have found that a thermoplastic elastomer composition containing specific component (A) and component (B) can achieve the above object.

Specifically, the gist of the present invention is as follows.

[1] An article having a plurality of seal lip parts,
wherein at least one of the seal lip parts is made of a thermoplastic elastomer composition comprising the following component (A) and component (B), and is a flocked seal lip part wherein fibers are flocked with a urethane-based resin adhesive.
   Component (A): A thermoplastic elastomer
   Component (B): A polyolefin having a repeating unit represented by the following formula (I)

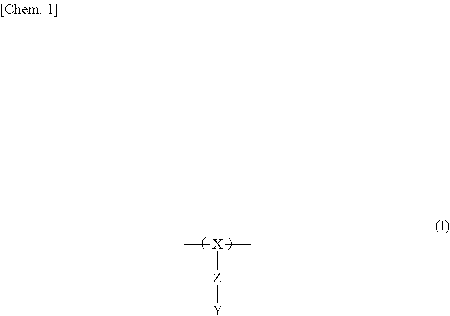

In the formula (I), X, Z, and Y are as follows.

X: A polyolefin main chain
Z: An organic group derived from an unsaturated carboxylic acid or its derivative
Y: An organic group derived from a polyalkylene ether glycol, or an organic group derived from a polyhydroxy polyolefin
[2] The article according to [1], wherein the seal lip parts are made of the thermoplastic elastomer composition.
[3] The article according to [1] or [2], wherein the article has a main body part,
the main body part is a molded body made of an olefin-based polymer, or a coated molded body having a metal core and a coating material coating the metal core, and
the main body part and the plurality of seal lip parts are integrally molded.
   [4] The article according to [2], wherein the main body is the coated molded body having a metal core and a coating material coating the metal core.
   [5] The article according to any one of [1] to [4], wherein the component (A) is an elastomer-based resin composition comprising an olefin-based elastomer and a propylene-based polymer.
   [6] The article according to [5], wherein the olefin-based elastomer is an ethylene-propylene-based copolymer elastomer having a Mooney viscosity ML₁₊₄ (125° C.) of 30 to 75.
   [7] The article according to [5] or [6], wherein the propylene-based polymer has an MFR of 0.1 to 35 g/10 min at 230° C. and a load of 21.18 N.
   [8] The article according to any one of [5] to [7],
   wherein the component (A) has an olefin-based elastomer content of 70 to 90% by mass and a propylene-based polymer content of 10 to 30% by mass based on 100% by mass of the total of the olefin-based elastomer and the propylene-based polymer.
   [9] The article according to any one of [1] to [8], wherein the thermoplastic elastomer composition contains 1 to 30 parts by mass of the component (B) based on 100 parts by mass of the component (A).
   [10] The article according to any one of [5] to [9], wherein the elastomer-based resin composition of the component (A) further comprises a styrene-based elastomer.
   [11] The article according to [10], wherein the styrene-based elastomer is at least one selected from the group consisting of a hydrogenated styrene-butadiene block copolymer and a hydrogenated styrene-isoprene block copolymer.
   [12] The article according to or [11], wherein the content of the styrene-based elastomer is 1% by mass or more and less than 50% by mass based on 100% by mass of the total of the olefin-based elastomer and the styrene-based elastomer.
   [13] The article according to any one of [1] to [12], wherein the thermoplastic elastomer composition is a crosslinked thermoplastic elastomer composition.
   [14] The article according to any one of [1] to [13], wherein the article is an automobile seal part.
   [15] A fiber-flocked seal lip member comprising a molded body and fibers flocked to the molded body with a urethane-based resin adhesive,
wherein the molded body is made of a thermoplastic elastomer composition comprising the following component (A) and component (B).
   Component (A): A thermoplastic elastomer
   Component (B): A polyolefin having a repeating unit represented by the following formula (I)

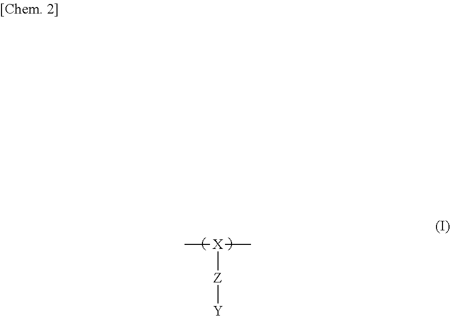

In the formula (I), X, Z, and Y are as follows.

X: A polyolefin main chain
Z: An organic group derived from an unsaturated carboxylic acid or its derivative
Y: An organic group derived from a polyalkylene ether glycol, or an organic group derived from a polyhydroxy polyolefin
[16] An article comprising:
a coated molded body; and
the fiber-flocked seal lip member according to fitted to the coated molded body,
wherein the coated molded body comprises a metal core and a coating material coating the metal core.
   [17] The article according to [16], wherein the article is an automobile seal part.
   [18] A crosslinked thermoplastic elastomer composition comprising the following component (A) and component (B).
   Component (A): A thermoplastic elastomer
   Component (B): A polyolefin having a repeating unit represented by the following formula (I)

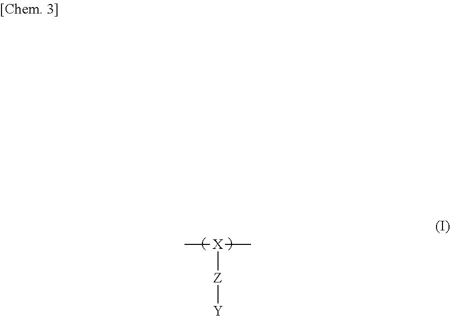

In the formula (I), X, Z, and Y are as follows.

X: A polyolefin main chain
Z: An organic group derived from an unsaturated carboxylic acid or its derivative
Y: An organic group derived from a polyalkylene ether glycol, or an organic group derived from a polyhydroxy polyolefin
[19] The crosslinked thermoplastic elastomer composition according to [18], wherein the component (B) is an esterification reaction product of a modified polyolefin modified with an unsaturated carboxylic acid and/or its derivative, and a polyalkylene ether glycol and/or a polyhydroxy polyolefin.
[20] The crosslinked thermoplastic elastomer composition according to or [19], wherein the component (A) comprises an olefin-based elastomer.
[21] The crosslinked thermoplastic elastomer composition according to [20], wherein the component (A) further comprises a styrene-based elastomer.
[22] The crosslinked thermoplastic elastomer composition according to or [21], wherein the olefin-based elastomer is an ethylene-propylene-based copolymer elastomer having a Mooney viscosity ML₁₊₄ (125° C.) of 30 to 75.
[23] A method for producing a crosslinked thermoplastic elastomer composition according to any one of to [22],
wherein the method comprises a step of reacting a mixture containing the following components (a)′, (b) and (c), and
a part of the component (a)′ is crosslinked in the step.
   Component (a)′: A crosslinkable thermoplastic elastomer
   Component (b): A polyalkylene ether glycol and/or a polyhydroxy polyolefin
   Component (c): A modified polyolefin modified with an unsaturated carboxylic acid and/or its derivative
   [24] The method for producing a crosslinked thermoplastic elastomer composition according to [23], wherein the mixture comprises 0.1 to 10 parts by mass of the component (b) and 1 to 20 parts by mass of the component (c) based on 100 parts by mass of the component (a)′.
   [25] The method for producing a crosslinked thermoplastic elastomer composition according to or [24], wherein the mixture further comprises a hydrocarbon-based rubber softener as a component (d).
   [26] The method for producing a crosslinked thermoplastic elastomer composition according to [25], wherein the mixture comprises 0.1 to 10 parts by mass of the component (b) and 1 to 20 parts by mass of the component (c) based on the total of 100 parts by mass of the component (a)′ and component (d).
   [27] The method for producing a crosslinked thermoplastic elastomer composition according to any one of to [26], wherein the number average molecular weight of the polyalkylene ether glycol and/or polyhydroxy polyolefin of the component (b) is 200 to 5000.

### Advantageous Effects of Invention

The article of the present invention can provide an article having excellent adhesion and excellent flocking durability of the flocked fibers, a fiber-flocked seal lip member, and an article using the fiber-flocked seal lip member.

The article and fiber-flocked seal lip member of the present invention are particularly suitable for use as automobile seal parts.

The crosslinked thermoplastic elastomer composition of the present invention has excellent adhesion to adhesive, different resins, paint, metal, and glass. Therefore, the crosslinked thermoplastic elastomer composition of the present invention is expected to be used in automobile parts, building parts, medical parts, food parts, packaging materials, miscellaneous goods, clothing products, sporting goods, and the like.

### BRIEF DESCRIPTION OF DRAWINGS

FIG. 1 is a schematic cross-sectional view of an example of an automobile weather strip.

FIG. 2 is a schematic cross-sectional view of another example of an automobile weather strip.

FIG. 3(a) and FIG. 3(b) are respectively a schematic cross-sectional view of other example of an automobile weather strip.

FIG. 4 is a schematic cross-sectional view of a different example of an automotive weather strip.

### DESCRIPTION OF EMBODIMENTS

The embodiments of the present invention will be described in detail below. The following description of the components is an example of the embodiment of the present invention, and the present invention is not limited to the following description as long as it does not exceed the gist of the invention.

In the present invention, when the expression “to” is used with numerical value or physical property values before and after it, it is used as including the values before and after it. In addition, numerical values or physical property values written as upper and lower limits are used to mean that the values are included.

First, the thermoplastic elastomer composition (hereinafter, sometimes referred to as the “thermoplastic elastomer composition of the present invention”) which is the constituent material of the seal lip part of the article of the present invention or the molded body of the fiber-flocked seal lip member of the present invention, and the crosslinked thermoplastic elastomer composition of the present invention will be described.

### (Thermoplastic Elastomer Composition and Crosslinked Thermoplastic Elastomer Composition)

The thermoplastic elastomer composition of the present invention is a thermoplastic elastomer composition containing the following component (A) and component (B), and is preferably a crosslinked thermoplastic elastomer composition.

Component (A): A thermoplastic elastomer
Component (B): A polyolefin having a repeating unit represented by the following formula (I)

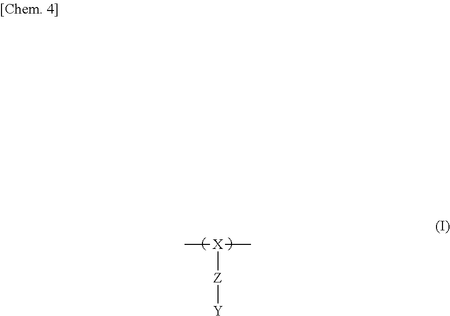

In the formula (I), X, Z, and Y are as follows.

X: A polyolefin main chain
Z: An organic group derived from an unsaturated carboxylic acid or its derivative
Y: An organic group derived from a polyalkylene ether glycol, or an organic group derived from a polyhydroxy polyolefin

The thermoplastic elastomer composition of the present invention is preferably a thermoplastic elastomer composition obtained by reacting the following components (a) to (c) in the presence of the following component (e).

Component (a): A thermoplastic elastomer
Component (b): A polyalkylene ether glycol and/or a polyhydroxy polyolefin
Component (c): A modified polyolefin modified with an unsaturated carboxylic acid and/or its derivative
Component (e): A peroxide

The crosslinked thermoplastic elastomer composition of the present invention can be preferably produced, for example, in a step of reacting a mixture the containing component (a)′, the component (b) and the component (c) in the presence of the following component (e) to crosslink a part of the component (a)′.

Component (a)′: A crosslinkable thermoplastic elastomer
Component (b): A polyalkylene ether glycol and/or a polyhydroxy polyolefin
Component (c): A modified polyolefin modified with an unsaturated carboxylic acid and/or its derivative Component (e): A peroxide

In other words, in the present invention, the component (a) is a thermoplastic elastomer as a raw material of the thermoplastic elastomer composition of the present invention, and the component (A) means a thermoplastic elastomer contained in the thermoplastic elastomer composition of the present invention.

Similarly, the component (a)′ is a crosslinkable thermoplastic elastomer as a raw material of a crosslinked thermoplastic elastomer composition suitable as the thermoplastic elastomer composition of the present invention, and the crosslinked thermoplastic elastomer composition of the present invention contains a thermoplastic elastomer obtained by crosslinking the crosslinkable thermoplastic elastomer of the component (a)′.

The above component (A) and component (a) have the same meaning. In the following, although the component (a) is sometimes described as the component (A), the description applies with the “component (A)” replaced with the “component (a)”. Similarly, the description of the “component (a)” can be substituted for the “component (A)”.

### [Mechanism]

The mechanism by which the thermoplastic elastomer composition of the present invention has adhesive properties is presumably due to the fact that, in the thermoplastic elastomer composition of the present invention, the component (B) provides the effect of enhancing adhesiveness to adhesive, other resins, paint, metal, or glass, while the component (A) provides flexibility.

### [Component (A): Thermoplastic Elastomer]

The thermoplastic elastomer of the component (A) can be any known thermoplastic elastomer. However, from the viewpoints of lightweight and mechanical properties, it is preferably at least one selected from the group consisting of olefin-based elastomers and styrene-based elastomers.

Examples of the olefin elastomers include ethylene-propylene copolymer rubber (EPM), ethylene-propylene-non-conjugated diene copolymer rubber (EPDM), ethylene-butene copolymer rubber (EBM), ethylene-propylene-butene copolymer rubber, and ethylene-octene copolymer rubber (EOM). Among these, preferred are ethylene-butene-non-conjugated diene copolymer rubber (EBDM) and ethylene-octene copolymer rubber (EOM). These are also suitable as the crosslinkable thermoplastic elastomer of the component (a)′.

Examples of styrene-based elastomers include styrene-butadiene block copolymers, styrene-isoprene block copolymers, hydrogenated products thereof, and products modified with an acid anhydride or the like to introduce a polar functional group; and products obtained by grafting, randomly and/or block copolymerizing other monomers.

Specific examples include styrene-based elastomers containing one or more types of styrene-butadiene-styrene copolymers (SBS) and styrene-ethylene-butylene-styrene copolymers (SEBS).

The thermoplastic elastomer also includes a compound containing the above mentioned elastomer component and polymer component other than the elastomer. The compound may be a crosslinked compound. As the polymer component other than the elastomer, olefin-based polymers such as polypropylene-based polymers, polyethylene-based polymers, and the like are preferred from the viewpoints of light weight and mechanical properties.

That is, the thermoplastic elastomer of the component (A) is generally provided as an elastomer-based resin composition containing one or more of the above mentioned various elastomers and a polymer component other than the elastomer. Therefore, not only the elastomer alone but also the elastomer-based resin composition containing an elastomer are included in the thermoplastic elastomer of the component (A) according to the present invention.

When the component (A) is the elastomer-based resin composition containing a thermoplastic elastomer and a polymer component other than an elastomer, the elastomer-based resin composition is preferably an elastomer-based resin composition containing an olefin-based elastomer and a propylene-based polymer (hereinafter, sometimes referred to as “elastomer-based resin composition (1)”), or an elastomer-based resin composition containing an olefin-based elastomer, a styrene-based elastomer, and a propylene-based polymer (hereinafter, sometimes referred to as “elastomer-based resin composition (2)”).

More preferred embodiments of the elastomer-based resin composition (1) and the elastomer-based resin composition (2) will be described later in the description about an article of the present invention.

The thermoplastic elastomer of the component (A) may be used alone or in a mixture of two or more types.

### [Component (B)]

The component (B) is a polyolefin having a repeating unit represented by the following formula (I).

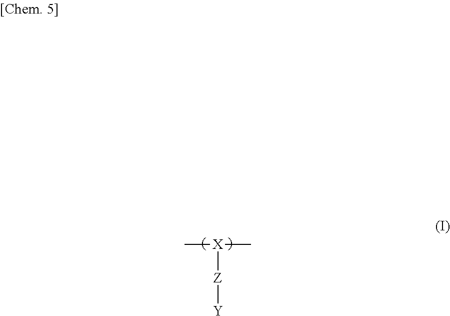

In the formula (I), X, Z, and Y are as follows.

X: A polyolefin main chain
Z: An organic group derived from an unsaturated carboxylic acid or its derivative
Y: An organic group derived from a polyalkylene ether glycol, or an organic group derived from a polyhydroxy polyolefin

Examples of the polyolefin having the repeating unit represented by the formula (I) of the component (B) include an esterification product of a modified polyolefin modified with an unsaturated carboxylic acid and/or its derivative of the component (c) and a polyalkylene ether glycol and/or a polyhydroxy polyolefin of the component (b).

A polyalkylene ether glycol or a polyhydroxy polyolefin has multiple hydroxyl groups in the main chain of the polyalkylene ether or the polyolefin, and the main chain portion enhances compatibility with the component (A), while the hydroxyl groups contribute to reactivity with the modified polyolefin and adhesion to adhesive, different resins, paint, and metal. Therefore, an esterification product of a modified polyolefin and a polyalkylene ether glycol and/or a polyhydroxy polyolefin exhibits excellent effects in improving compatibility with the thermoplastic elastomer of the component (A) and adhesion to adhesive, different resins, paint, and metal.

<Component (b): Polyalkylene Ether Glycol and/or Polyhydroxy Polyolefin>

A polyalkylene ether glycol is usually a polyhydroxy compound having one or more ether bonds in the main skeleton in the molecule.

Examples of repeating units in the main skeleton of a polyalkylene ether glycol include, for example, saturated hydrocarbon groups having 1 to 20 carbon atoms, such as 1,2-ethylene glycol units, 1,2-propylene glycol units, 1,3-propanediol (trimethylene glycol) units, 2-methyl-1,3-propanediol units, 2,2-dimethyl-1,3-propanediol units, 1,4-butanediol (tetramethylene glycol) units, 2-methyl-1,4-butanediol units, 3-methyl-1,4-butanediol units, 3-methyl-1,5-pentanediol units, neopentyl glycol units, 1,6-hexanediol units, 1,7-heptanediol units, 1,8-octanediol units, 1,9-nonanediol units, 1,10-decanediol units, 1,4-cyclohexanedimethanol units, and the like. A homopolymerized polyalkylene ether glycol may be formed from only one of these repeating units, or a copolymerized polyalkylene ether glycol may be formed from two or more repeating units.

Among the polyalkylene ether glycols having the above repeating units in the main skeleton, polyethylene glycol, polypropylene glycol, polytetramethylene ether glycol (PTMG), copolymerized polytetramethylene ether glycol of 3-methyltetrahydrofuran and tetrahydrofuran, copolymerized polyether polyol of neopentyl glycol and tetrahydrofuran, copolymerized polyether polyol of ethylene oxide and tetrahydrofuran, and copolymerized polyether glycol of propylene oxide and tetrahydrofuran are preferable as the polyalkylene ether glycol used in the present invention from the viewpoints of the mechanical strength and adhesive strength of the resulting thermoplastic elastomer composition. Among these, polytetramethylene ether glycol (PTMG) is more preferable.

Although the molecular weight of the polyalkylene ether glycol is not particularly limited, a number average molecular weight (Mn) of 200 to 5000, particularly 200 to 4500, is preferred for various applications.

The number average molecular weight (Mn) of the polyalkylene ether glycol can be analyzed by gel permeation chromatography (GPC). In the present invention, the POLYTETRAHYDROFURAN calibration kit manufactured by POLYMER LABORATORIES, UK, was used for calibration of the GPC.

The number average molecular weight (Mn) of the polytetramethylene ether glycol used in Examples and Comparative Examples described below was also measured by this method.

Polyalkylene ether glycols are commercially available. For example, the PTMG series and BioPTMG series manufactured by Mitsubishi Chemical Corporation can be used.

Only one type of the polyalkylene ether glycol may be used, or two or more types having different compositions, physical properties, and the like may be used in combination.

Examples of the polyhydroxypolyolefin include polyhydroxypolybutadiene or its hydrogenated products. Specifically, they include polymers that have at least one hydroxyl group at the end and have a number average molecular weight (Mn) of usually 200 to 10,000, preferably 200 to 8,000, and more preferably 200 to 5,000, and are liquid, semi-solid, or solid at normal temperature.

The average number of hydroxyl groups per molecule of the polyhydroxypolyolefin is 1 to 10, preferably 1.5 to 5, and the hydroxyl value of the polyhydroxypolyolefin is usually 15 to 250 mg-KOH/g, and preferably 2 to 125 mg-KOH/g.

The number average molecular weight (Mn) of the polyhydroxypolyolefin can be analyzed by gel permeation chromatography (GPC).

The hydroxyl value of the polyhydroxypolyolefin can be analyzed by a neutralization titration method, a potentiometric titration method, and a pyridine-acetyl chloride method as specified in JIS K0070.

Polyhydroxypolyolefins are commercially available. For example, Polytail® (registered trademark) H manufactured by Mitsubishi Chemical Corporation, Poly bd series manufactured by Idemitsu Kosan Co., Ltd., GI series, which is liquid hydrogenated polybutadiene having hydroxyl groups at both ends, manufactured by Nippon Soda Co., Ltd. can be used.

Only one type of the polyhydroxypolyolefins may be used, or two or more types having different compositions, physical properties, and the like may be used in combination.

One or more types of the polyalkylene ether glycols may be used in combination with one or more types of the polyhydroxypolyolefins.

< (c): Modified Polyolefin Modified with Unsaturated Carboxylic Acid and/or its Derivative>

Although the unsaturated carboxylic acid used to modify the polyolefin is not particularly limited, examples include acrylic acid, methacrylic acid, maleic acid, fumaric acid, itaconic acid, nadic acid, and citraconic acid. Examples of the derivatives of the unsaturated carboxylic acids include their acid anhydrides, esters, amides, imides, metal salts, and the like.

Specific examples of derivatives of unsaturated carboxylic acids include maleic anhydride, nadic anhydride, itaconic anhydride, citraconic anhydride, methyl acrylate, methyl methacrylate, ethyl acrylate, ethyl methacrylate, glycidyl acrylate, maleic acid monoethyl ester, maleic acid diethyl ester, itaconic acid monomethyl ester, itaconic acid diethyl ester, acrylamide, methacrylamide, maleic acid monoamide, maleic acid diamide, maleic acid-N-monoethylamide, maleic acid-N, N-diethylamide, maleic acid-N, N-monobutylamide, maleic acid-N, N-dibutylamide, fumaric acid monoamide, fumaric acid diamide, fumaric acid-N-monobutylamide, fumaric acid-N, N-dibutylamide, maleimide, N-butylmaleimide, N-phenylmaleimide, sodium acrylate, sodium methacrylate, potassium acrylate, and potassium methacrylate.

These unsaturated carboxylic acids and/or derivatives thereof may be used alone or in combination of two or more.

Among these, maleic acid and/or its anhydride are preferred because of their low electron density and high reactivity.

Examples of the polyolefins to be modified include polypropylene, polyethylene, polybutene, and copolymers thereof, ethylene-vinyl acetate copolymers, ethylene-acrylic acid ester copolymers, and the like.

The content of the unsaturated carboxylic acid and/or its derivative contained in the modified polyolefin is preferably 0.01 to 5% by mass, and more preferably 0.1 to 4% by mass. By setting the content of the unsaturated carboxylic acid and/or its derivative contained in the modified polyolefin within the above range, it is possible to suppress the generation of unreacted substances and by-products due to the crosslinking reaction while maintaining good adhesion. As a result, in a molded article using the obtained thermoplastic elastomer composition, deterioration of the product appearance due to fish eyes, bumps, and the like can be prevented, and a decrease of adhesiveness tends to be suppressed.

The content of the unsaturated carboxylic acid and/or its derivative in the modified polyolefin is the content of the components derived from the unsaturated carboxylic acid and/or its derivative contained in the modified polyolefin, and usually corresponds to the percentage of the amount of the unsaturated carboxylic acid and/or its derivative used in modifying the polyolefin relative to the modified polyolefin.

The lower limit of the acid value of the modified polyolefin is preferably 4 mg-KOH/mg or more, and more preferably 4.5 mg-KOH/mg or more, from the viewpoint of obtaining a sufficient esterification product. On the other hand, the upper limit of the acid value of the modified polyolefin is preferably 80 mg-KOH/mg or less, and more preferably 70 mg-KOH/mg or less, from the viewpoint of odor derived from the unsaturated carboxylic acid and/or its derivative as the modifier.

The molecular weight of the modified polyolefin is usually preferably a weight average molecular weight (Mw) of 9000 or more from the viewpoint of adhesiveness.

The modified polyolefin of the component (c) may be used alone or in combination of two or more types of the unsaturated carboxylic acid and/or its derivative as a modifier, or the polyolefins subjected to modification which differ in types, physical properties and the like.

### <Esterification>

The component (B) is obtained by mixing the aforementioned component (b): the polyalkylene ether glycol and/or the polyhydroxy polyolefin, and the component (c): the modified polyolefin modified with the unsaturated carboxylic acid and/or its derivative, and esterifying the terminal hydroxyl group of the polyalkylene ether glycol and/or the polyhydroxy polyolefin to the carboxylic acid portion of the modified polyolefin.

Although the method for mixing the component (b) and the component (c) for this esterification reaction can be a known mixing method, a method of mixing by melt kneading is preferred in terms of equipment, time, and environment.

In the method of modifying the component (c) with the component (b) by melting the component (b) and the component (c) and carrying out an esterification reaction, a kneading machine is usually used. As the kneading machine, a Banbury mixer (intensive mixer), a pressure kneader, a twin-screw extruder, or the like can be used.

The Banbury mixer has two rotors arranged in a mixing chamber, which rotate in different directions to knead the compounded materials. In addition, a pressure can be applied to the compounded materials by a pressure ram. And the compounded materials can be heated or cooled from the outside through the jacket.

The pressure kneader has two blades arranged in a mixing chamber, which rotate in different directions to knead the compounded materials. In addition, a pressure can be applied to the compounded materials by a pressure cylinder. And the compounded materials can be heated or cooled from the outside through the jacket.

The twin-screw extruder has two screws arranged in a cylinder, which rotate in the same or different directions to transport the compounded materials back and forth and to knead them by applying pressure and shear force. The outer wall of the cylinder is surrounded by a heater and a cooling jacket, so that the compounded materials can be heated or cooled from the outside.

The modification of the component (c) by the component (b) using a kneading machine is usually carried out at a temperature of about 160 to 350° C., according to the setting conditions of the kneading machine used.

As described below, the modification of the component (c) by the component (b) can be carried out in the presence of the thermoplastic elastomer of the component (a).

### [Component (d): Hydrocarbon-Based Rubber Softener]

The thermoplastic elastomer composition of the present invention preferably contains a hydrocarbon-based rubber softener as the component (d) in order to soften the resulting thermoplastic elastomer composition, and increase its flexibility and elasticity, as well as improve the processability and flowability of the resulting thermoplastic elastomer composition.

Examples of the hydrocarbon-based rubber softener include a mineral oil-based softener, a synthetic resin-based softener, and the like. Among these, a mineral oil-based softener is particularly preferred.

A mineral oil-based softener is generally a mixture of an aromatic hydrocarbon, a naphthenic hydrocarbon, and a paraffinic hydrocarbon. A mineral oil-based softener in which the ratio of carbon atoms in the paraffinic hydrocarbon to the total carbon atoms in the softener is 50% or more is called a paraffinic oil. A mineral oil-based softener in which the ratio of carbon atoms in the naphthenic hydrocarbon to the total carbon atoms in the softener is 30 to 45% is called a naphthenic oil. A mineral oil-based softener in which the ratio of carbon atoms in the aromatic hydrocarbon to the total carbon atoms in the softener is 35% or more is called an aromatic oil. Among these, a paraffinic oil is more preferred.

The kinetic viscosity at 40° C. of the hydrocarbon-based rubber softener of the component (d) is preferably 20 centistokes (cSt) or more, and more preferably 50 cSt or more, and preferably 800 cSt or less, and more preferably 600 cSt or less.

The flash point (COC method) of the hydrocarbon-based rubber softener is preferably 200° C. or higher, and more preferably 250° C. or higher.

The hydrocarbon-based rubber softener of the component (d) may be a commercially available product. Examples of the commercially available product of the component (d) include “Nisseki Polybutene (registered trademark) HV” series manufactured by JX Nippon Oil & Energy Corporation and “Diana (registered trademark) Process Oil PW” series manufactured by Idemitsu Kosan Co., Ltd. The component (d) can be appropriately selected from these and used.

Only one hydrocarbon-based rubber softener of the component (d) may be used alone, or two or more hydrocarbon-based rubber softener may be used in any combination at any ratio.

### <Component (e): Peroxide>

The peroxide of the component (e) is used as a radical initiator in crosslinking when the crosslinkable thermoplastic elastomer of the component (a)′ is used as the thermoplastic elastomer of the component (a).

As the peroxide, either an aromatic organic peroxide or an aliphatic organic peroxide can be used. Specific examples of the peroxide include dialkyl peroxides such as di-t-butyl peroxide, t-butylcumyl peroxide, dicumyl peroxide, 2,5-dimethyl-2,5-di(t-butylperoxy) hexane, 2,5-dimethyl-2,5-di(t-butylperoxy) hexyne-3,1,3-bis(t-butylperoxyisopropyl)benzene, 1,1-di(t-butylperoxy)-3,3,5-trimethylcyclohexane, and the like; peroxy esters such as t-butylperoxybenzoate, t-butylperoxy-2-ethylhexanoate, t-butylperoxyisopropyl carbonate, 2,5-dimethyl-2,5-di(benzoylperoxy) hexane, 2,5-dimethyl-2,5-di(benzoylperoxy) hexyne-3, and the like; hydroperoxides such as acetyl peroxide, lauroyl peroxide, benzoyl peroxide, p-chlorobenzoyl peroxide, 2,4-dichlorobenzoyl peroxide, and the like; diacyl peroxides such as di-3,5,5-trimethylhexanoyl peroxide, octanoyl peroxide, dibenzoyl peroxide, and the like; and ketone peroxides such as methyl ethyl ketone peroxide, cyclohexanone peroxide, and the like.

The peroxides listed above may be used alone or in combination of two or more.

Among these, peroxides having a 1-minute half-life temperature of 100° C. or higher are preferred from the viewpoint of crosslinking efficiency. Specifically, dialkyl peroxides such as di-t-butyl peroxide, dicumyl peroxide, 2,5-dimethyl-2,5-di(t-butylperoxy) hexane, 2,5-dimethyl-2,5-di(t-butylperoxy) hexyne-3, and the like, or peroxy esters such as t-butylperoxybenzoate, t-butylperoxy-2-ethylhexanoate, 2,5-dimethyl-2,5-di(benzoylperoxy) hexane, 2,5-dimethyl-2,5-di(benzoylperoxy) hexyne-3, and the like are preferred.

The amount of the peroxide used is usually 0.01 parts by mass or more, and preferably 0.1 parts by mass or more, and usually 3 parts by mass or less, and preferably 2 parts by mass or less, based on 100 parts by mass of the thermoplastic elastomer of the component (a). By using an amount of the peroxide equal to or more than the above mentioned lower limit, crosslinking can be performed efficiently. By using an amount of the peroxide equal to or less than the above mentioned upper limit, the occurrence of defects in the molded appearance due to over-crosslinking can be reduced.

A crosslinking aid can be used in combination with the peroxide as the component (f). Examples of the crosslinking aids include peroxy crosslinking aids such as sulfur, p-quinone dioxime, nitrosobenzene, diphenyl guanidine, N-methyl-N-4-dinitrosoaniline, N,N′-m-phenylene bismaleimide, and the like, divinylbenzene, triallyl cyanurate, polyfunctional methacrylate monomers such as ethylene glycol dimethacrylate, diethylene glycol dimethacrylate, polyethylene glycol dimethacrylate, trimethylolpropane trimethacrylate, allyl methacrylate, and the like, and polyfunctional vinyl monomers such as vinyl butyrate, vinyl stearate, and the like. By using these crosslinking aids in combination, a uniform and gentle crosslinking reaction can be expected.

The amount of the crosslinking aid used is usually selected from the range of 0.005 to 4 parts by mass, and preferably 0.05 to 3 parts by mass based on 100 parts by mass of the thermoplastic elastomer of the component (a). When the amount of the crosslinking aid used is equal to or more than the above mentioned lower limit, the effect of the crosslinking aid can be effectively obtained, and when it is equal to or less than the above mentioned upper limit, it is economical.

### [Content Ratio]

The thermoplastic resin elastomer composition of the present invention preferably contains 1 to 30 parts by mass of the component (B) based on 100 parts by mass of the component (A) from the viewpoint of adhesiveness. From the viewpoint of stable adhesiveness, the lower limit of the content of the component (B) is more preferably 1.5 parts by mass or more, and even more preferably 2.0 parts by mass or more. On the other hand, the upper limit of the content of the component (B) is preferably 30 parts by mass or less, and more preferably 20 parts by mass or less, from the viewpoint of handling during production.

Here, it is difficult to quantitatively determine the content of the component (B), which is an esterification product of the component (b) and the component (c), by analysis. The total amount of the component (b) and the component (c) used as raw materials for the esterification product can be regarded as the amount of the component (B).

### [Other Components]

In addition to the above mentioned component (A) (component (a)), component (B) (components (b) and (c)), and component (d), other components can be blended into the thermoplastic elastomer composition of the present invention according to the purpose, as long as they do not impair the effects of the present invention.

Examples of other components include various additives such as a filler, an antioxidant, a heat stabilizer, a light stabilizer, an ultraviolet absorber, a neutralizing agent, a lubricant, an antifogging agent, an antiblocking agent, a slip agent, a dispersing agent, a colorant, a flame retardant, an antistatic agent, a conductivity imparting agent, a metal deactivator, a molecular weight modifier, an antimicrobial agent, an antifungal agent, a fluorescent brightening agent, and the like. Any of the additives may be used alone or in combination of two or more.

Examples of the filler include glass fibers, hollow glass balls, carbon fibers, alumina, talc, calcium carbonate, mica, potassium titanate fibers, silica, metal soap, calcium carbonate, titanium dioxide, carbon black, boron nitride, and the like.

These fillers may be used alone, or two or more of them may be used in any combination and ratio.

Examples of the heat stabilizer that can be used include phosphorus compounds such as aliphatic, aromatic, or alkyl group-substituted aromatic esters of phosphoric acid or phosphorous acid, hypophosphorous acid derivatives, phenylphosphonic acid, phenylphosphinic acid, diphenylphosphonic acid, polyphosphonates, dialkyl pentaerythritol diphosphites, dialkyl bisphenol A diphosphites, and the like; phenol-based derivatives, particularly hindered phenol compounds; sulfur-containing compounds such as thioether-based compounds, dithioacid salt-based compounds, mercaptobenzimidazole-based compounds, thiocarbanilide-based compounds, thiodipropionate-based compounds, and the like; and tin compounds such as tin maleate, dibutyltin monoxide, and the like.

Examples of the hindered phenol compound include “Irganox® 1010”, and “Irganox® 1520” (both trade names, manufactured by BASF Japan Co., Ltd.), and the like.

Examples of the phosphorus compound include “PEP-36”, “PEP-24G”, and “HP-10” (all of which are product names manufactured by ADEKA Corporation), “Irgafos168” (product name manufactured by BASF Japan Co., Ltd.), and the like.

Examples of the sulfur-containing compound include thioether compounds such as dilauryl thiopropionate (DLTP), distearyl thiopropionate (DSTP), and the like.

The lower limit of the amount of these heat stabilizers to be added is preferably 0.01 parts by mass, and more preferably 0.05 parts by mass, as a mass ratio based on 100 parts by mass of the thermoplastic elastomer composition. On the other hand, the upper limit of the amount to be added is preferably 1 part by mass, and more preferably 0.5 parts by mass. By setting the amount of the heat stabilizer to be equal to or more than the above mentioned lower limit, the effect of adding the heat stabilizer can be sufficiently obtained. By setting the amount of the heat stabilizer to be equal to or less than the above mentioned upper limit, the precipitation of the heat stabilizer can be suppressed.

Examples of the light stabilizer include benzotriazole-based and benzophenone-based compounds, and the like. Specifically, “TINUVIN 622LD” and “TINUVIN 765” (all trade names: manufactured by BASF Japan Co., Ltd.), “SANOLLS-2626” and “SANOLLS-765” (all trade names: manufactured by Sankyo Co., Ltd.) can be used.

Examples of the ultraviolet absorber include “TINUVIN 328” and “TINUVIN 234” (all trade names: manufactured by BASF Japan Co., Ltd.), and the like.

The lower limit of the amount of these light stabilizers and the ultraviolet absorbers to be added is preferably 0.01 parts by mass, and more preferably 0.05 parts by mass, as a mass ratio based on 100 parts by mass of the thermoplastic elastomer composition, respectively. On the other hand, the upper limit of the amount to be added is preferably 1 part by mass, and more preferably 0.5 parts by mass, respectively. By setting the amount of the light stabilizer and the ultraviolet absorber to be equal to or more than the above mentioned lower limit, the effect of adding the light stabilizer and the ultraviolet absorber can be sufficiently obtained. By setting the amount of the light stabilizer and the ultraviolet absorber to be equal to or less than the above mentioned upper limit, the precipitation of the light stabilizer and the ultraviolet absorber can be suppressed.

Examples of the colorant include dyes such as direct dyes, acid dyes, basic dyes, metal complex salt dyes, and the like; inorganic pigments such as carbon black, titanium oxide, zinc oxide, iron oxide, mica, and the like; and organic pigments such as coupling azo pigments, condensed azo pigments, anthraquinone pigments, thioindigo pigments, dioxazone pigments, phthalocyanine pigments, and the like.

Examples of the flame retardant include additive and reactive type flame retardants such as phosphorus- and halogen-containing organic compounds, bromine- or chlorine-containing organic compounds, ammonium polyphosphate, aluminum hydroxide, antimony oxide, and the like.

These additives may be used alone or in any combination of two or more in any ratio.

### (Method for Producing Thermoplastic Elastomer Composition and Crosslinked Thermoplastic Elastomer Composition)

The thermoplastic elastomer composition of the present invention is obtained by melt-kneading the component (A) and the component (B) using the above mentioned kneading machine or the like. When producing the component (B), the thermoplastic elastomer (the component (a)) can be added at the same time to obtain the thermoplastic elastomer composition of the present invention. In this case, it is preferable to use the above mentioned kneading machine, and it is more preferable to use a twin-screw kneader.

As mentioned above, the crosslinked thermoplastic elastomer composition of the present invention is a preferred embodiment of the thermoplastic elastomer composition of the present invention, and the following description of the method for producing the thermoplastic elastomer composition corresponds to the method for producing the crosslinked thermoplastic elastomer composition of the present invention.

The thermoplastic elastomer composition and the crosslinked thermoplastic elastomer composition of the present invention can also be obtained by reacting a mixture containing the component (a): the thermoplastic elastomer (including the above mentioned elastomer-based resin composition), the component (b): the polyalkylene ether glycol and/or the polyhydroxy polyolefin, the component (c): the modified polyolefin modified with the unsaturated carboxylic acid and/or its derivative, and more preferably a mixture containing the component (e): the peroxide.

The mixture preferably contains 0.1 to 10 parts by mass of the component (b), 1 to 20 parts by mass of the component (c), and 0.01 to 3 parts by mass of the component (e) based on 100 parts by mass of the component (a).

When the mixture further contains a hydrocarbon-based rubber softener as the component (d), the mixture preferably contains 0.1 to 10 parts by mass of the component (b), 1 to 20 parts by mass of the component (c), and 0.01 to 3 parts by mass of the component (e) based on 100 parts by mass of the total of the component (a) and the component (d).

When producing the thermoplastic elastomer composition of the present invention, a dynamic heat treatment is preferable to carry out in which heating and melt-kneading are carried out in the presence of the component (e) and a crosslinking aid of the component (f).

The component (g) used in the Examples shown below is a curing catalyst. Examples of the curing catalyst include one or more compounds selected from the group consisting of metal organic acid salts, titanates, borates, organic amines, ammonium salts, phosphonium salts, inorganic acids, organic acids, and inorganic acid esters, and the like.

Examples of the metal organic acid salt include dibutyltin dilaurate, dioctyltin dilaurate, dibutyltin diacetate, dibutyltin dioctoate, stannous acetate, stannous octoate, cobalt naphthenate, lead octoate, lead naphthenate, zinc octoate, zinc caprylate, iron 2-ethylhexanoate, iron octoate, and iron stearate.

Examples of the titanate include tetrabutyl titanate, tetranonyl titanate, and bis(acetylacetonitrile) diisopropyl titanate.

Examples of the organic amine include ethylamine, dibutylamine, hexylamine, triethanolamine, dimethyl soya amine, tetramethylguanidine, and pyridine.

Examples of the ammonium salt include ammonium carbonate and tetramethylammonium hydroxide.

Examples of the phosphonium salt include tetramethylphosphonium hydroxide.

Examples of the inorganic acid and the organic acid include sulfuric acid, hydrochloric acid, acetic acid, stearic acid, maleic acid, and sulfonic acids such as toluenesulfonic acid, alkylnaphthylsulfonic acids, and the like.

Examples of the inorganic acid ester include phosphoric acid esters.

Among these, preferred are metal organic acid salts, sulfonic acids, and phosphoric acid esters, and more preferred are metal carboxylates of tin such as dioctyltin dilaurate, alkylnaphthylsulfonic acids, and ethylhexyl phosphoric acid ester.

These curing catalysts may be used alone or in any combination of two or more in any ratio.

### (Molding/Applications)

The thermoplastic elastomer composition and the crosslinked thermoplastic elastomer composition of the present invention can be molded into molded articles by commonly used molding methods, such as an injection molding, an extrusion molding, a blow molding, a compression molding, and a vacuum molding. Among these, molded articles obtained by an injection molding and an extrusion molding are preferred. In addition, after these moldings, the molded article may be subjected to secondary processing such as a lamination molding or a thermoforming.

The thermoplastic elastomer composition and the crosslinked thermoplastic elastomer composition of the present invention can adhere to adhesive, different resins, paint, metal, or glass. For this reason, the thermoplastic elastomer composition and the crosslinked thermoplastic elastomer composition of the present invention can be used in a wide range of fields, such as civil engineering and building material parts (waterstop materials, joint materials, window frames), sporting goods, industrial parts (multi-layer hose tubes), home appliance parts (multi-layer hoses), medical parts (medical multi-layer containers), food parts (multi-layer packaging films, containers, bottles, decorative packaging, labels), electric wires, miscellaneous goods, and automobile parts (weather strips, ceiling materials, interior sheets, bumper moldings, side moldings, air spoilers, hoses, armrests, door trims, console lids, mats).

### [Article]

The article of the present invention is an article having a plurality of seal lip parts, wherein at least one of the seal lip parts is made of the thermoplastic elastomer composition of the present invention described above, and is a flocked seal lip part wherein fibers are flocked with a urethane-based resin adhesive.

In the article of the present invention, all of the multiple seal lip parts may be made of the thermoplastic elastomer composition of the present invention, or only a portion of the seal lip parts may be made of the thermoplastic elastomer composition of the present invention.

The article of the present invention may have a main body part which is a molded body made of an olefin-based polymer, or a coated molded body having a metal core and a coating material coating the metal core, and the main body part and the plurality of seal lip parts may be integrally molded. In this case, an olefin-based polymer is preferably used as the coating material for the coated molded body.

The article of the present invention may be made of a coated molded body in which a metal core is coated with a coating material, and fibers are flocked in a part of the coated molded body with a urethane-based resin adhesive to form the flocked seal lip part.

The seal lip part of the article of the present invention may be a protrusion integrated with the main body, like the seal lip part of an automobile weather strip described below, or may be a layer laminated on the surface of the main body.

### [Main Body Part]

The olefin-based polymer constituting the main body part is a chemically inert material. The olefin-based polymer may be a composition containing a thermoplastic elastomer in a proportion of usually 30% by mass or less.

The olefin-based polymer constituting the main body part may be a homopolymer of an α-olefin such as ethylene, propylene, butene-1,4-methylpentene-1, and the like, or a copolymer thereof. In particular, a propylene-based polymer, for example, isotactic polypropylene, a random or block copolymer of propylene and ethylene or an α-olefin such as ethylene, butene-1, or hexene-1, and the like is preferred. These olefin-based polymers are commercially available under various brands from various companies. For example, there is “Novatec” manufactured by Japan Polypropylene Corporation. In the present invention, these commercially available products can be suitably used by selecting a brand suitable for extrusion molding.

A composition of an olefin-based polymer and a thermoplastic elastomer can be obtained by blending an olefin-based polymer with an olefin-based or styrene-based rubber and a softener (optional component), and dynamically heat treating the blend in the presence or absence of an organic peroxide. Furthermore, rubbers other than those mentioned above can be used in combination as long as the object of the present invention is not impaired.

When the main body part is a coated molded body in which a metal core is coated with a coating material, the metal core may be, for example, various metal sheets having a thickness of 0.1 to 0.5 mm, more specifically, sheets of iron or plated iron.

The thickness of the main body part is usually in the range of 0.5 to 10 mm, and is appropriately designed according to the application.

### [Seal Lip Part]

In the present invention, the thermoplastic elastomer composition of the present invention is used for the seal lip part. The explanation of the thermoplastic elastomer composition of the present invention described above also applies to the thermoplastic elastomer composition constituting the seal lip part. As the thermoplastic elastomer of the component (A) constituting the thermoplastic elastomer composition, an elastomer-based resin composition (1) containing an olefin-based elastomer and a propylene-based polymer, or an elastomer-based resin composition (2) further containing a styrene-based elastomer is preferably used.

As the olefin-based elastomer, the one described above as the olefin-based elastomer of the component (A) used in the thermoplastic elastomer composition of the present invention can be preferably used. Among these, an ethylene-propylene-based copolymer elastomer having a Mooney viscosity ML₁₊₄ (125° C.) of 30 to 75 is preferred, and in particular, ethylene-propylene-non-conjugated diene copolymer rubber (EPDM) is preferred.

The EPDM may be an oil-extended type that contains oil in advance, or a non-oil-extended type that does not contain oil, or a combination of these. The non-oil-extended EPDM that does not contain oil in advance is economically inexpensive. On the other hand, the oil-extended EPDM tends to improve mechanical properties and moldability. As mentioned above, it is preferable to use any type of EPDM having a Mooney viscosity ML₁₊₄ (125° C.) of 30 to 75 when containing oil.

Examples of the above mentioned non-conjugated diene include dicyclopentadiene, 1,4-hexadiene, cyclooctadiene, methylenenorbornene, ethylidenenorbornene, and the like. Ethylidenenorbornene is particularly preferable.

Preferred specific examples of the olefin-based elastomer include EPDMs having an ethylene unit content of 55 to 75% by mass and a non-conjugated diene unit content of 1 to 10% by mass. When the content of ethylene unit is 55% by mass or more, it is easy to improve extrusion moldability. When the content of the ethylene unit is 75% by mass or less, flexibility tends to be easily to maintained. Here, flexibility is important from the viewpoint of providing an elastic recovery function that suppresses glass vibration (holds down the glass), for example, in the seal lip part of an automobile weather strip.

As these olefin-based elastomers, a commercially available product can be used. Specific examples of commercially available olefin-based elastomers include “Nordel® (registered trademark) IP4760P” (manufactured by Dow Chemical Company), “EPT3070”, “EPT3092M”, “EPT3062EM”, and “EPT3072EM” (all of which are product names manufactured by Mitsui Chemicals, Inc.), “EP24”, “EP57C”, “EP98”, and “EP505EC” (all of which are product names manufactured by JSR Corporation).

Examples of the propylene-based polymer include isotactic polypropylene, a random or block copolymer of propylene and ethylene or an α-olefin such as butene-1, hexene-1, and the like. Propylene-based polymers having a melt flow rate (MFR) of 0.1 to 35 g/10 min at 230° C. and a load of 21.18 N are particularly suitable. When the MFR is within the above range, an extrusion molding tends to be easy.

When the thermoplastic elastomer composition constituting the seal lip part is the elastomer-based resin composition (1) containing an olefin-based elastomer and a propylene-based polymer as the component (A), it is preferable that the content of the olefin-based elastomer is 60 to 95% by mass and the content of the propylene-based polymer is 5 to 40% by mass based on 100% by mass of the total of the olefin-based elastomer and the propylene-based polymer in said component (A), and it is more preferable that the content of the olefin-based elastomer is 70 to 90% by mass and the content of the propylene-based polymer is 10 to 30% by mass.

When the content of the olefin-based elastomer in the component (A) is equal to or more than the above mentioned lower limit and the content of the propylene-based polymer is equal to or less than the above mentioned upper limit, excellent flexibility tends to be obtained. When the content of the olefin-based elastomer is equal to or less than the above mentioned upper limit and the content of the propylene-based polymer is equal to or more than the above mentioned lower limit, excellent extrusion moldability tends to be obtained.

The thermoplastic elastomer composition constituting the seal lip part may be the elastomer-based resin composition (2) containing an olefin-based elastomer, a styrene-based elastomer, and a propylene-based polymer as the component (A). By further including a styrene-based elastomer in the component (A), the gloss (luster feal) of the surface of the seal lip part can be increased.

In this case, the styrene-based elastomers described above as the styrene-based elastomers of the component (A) used in the thermoplastic elastomer composition of the present invention can be suitably used as the styrene-based elastomers. Among these, hydrogenated styrene-butadiene block copolymers and hydrogenated styrene-isoprene block copolymers are preferred.

In the case of the elastomer-based resin composition (2) containing an olefin-based elastomer, a styrene-based elastomer, and a propylene-based polymer, the total content of the olefin-based elastomer and the styrene-based elastomer is preferably 60 to 95% by mass and the content of the propylene-based polymer is preferably 5 to 40% by mass based on 100% by mass of the total of the olefin-based elastomer, the styrene-based elastomer, and the propylene-based polymer, and more preferably the total content of the olefin-based elastomer and the styrene-based elastomer is 70 to 90% by mass and the content of the propylene-based polymer is 10 to 30% by mass. When the total content of the olefin-based elastomer and the styrene-based elastomer is equal to or more than the above mentioned lower limit and the content of the propylene-based polymer is equal to or less than the above mentioned upper limit, excellent flexibility tends to be obtained. When the total content of the olefin-based elastomer and the styrene-based elastomer is equal to or less than the above mentioned upper limit and the content of the propylene-based polymer is equal to or more than the above mentioned lower limit, excellent extrusion moldability tends to be obtained.

Furthermore, in this elastomer-based resin composition (2), the content of the styrene-based elastomer is preferably 18 by mass or more and less than 60% by mass, and the content of the olefin-based elastomer is preferably more than 40% by mass and 99% by mass or less, based on 100% by mass of the total of the olefin-based elastomer and the styrene-based elastomer, and more preferably the content of the styrene-based elastomer is 1 to 50% by mass, and the content of the olefin-based elastomer is more preferably 50 to 99% by mass. When the contents of the olefin-based elastomer and the styrene-based elastomer are within the above ranges, there is a tendency for the extrusion moldability to be excellent.

As the component (B) of the thermoplastic elastomer composition constituting the seal lip part, those described as the component (B) used in the thermoplastic elastomer composition of the present invention can be applied, and the same applies to the preferred components.

The thermoplastic elastomer composition constituting the seal lip part preferably contains 1 to 30 parts by mass of the component (B) per 100 parts by mass of the thermoplastic elastomer of the elastomer-based resin composition (1), the elastomer-based resin composition (2), or the like as the component (A). The lower limit of the content of the component (B) is more preferably 1.5 parts by mass or more, and even more preferably 2.0 parts by mass or more, from the viewpoint of stable adhesiveness. On the other hand, the upper limit of the content of the component (B) is preferably 30 parts by mass or less, and more preferably 20 parts by mass or less, from the viewpoint of handling during production.

As mentioned above, it is difficult to quantitatively determine the content of the component (B), which is an esterification product of the component (b) and the component (c), by analysis. The total amount of the component (b) and the component (c) used as raw materials for the esterification product can be regarded as the amount of the component (B).

The size of the seal lip part is appropriately determined depending on the application thereof.

### [Adhesive]

Usually, adhesives are broadly divided into two types: emulsion-based and solvent-based. Examples of emulsion-based adhesive include acrylic ester resin, acrylic ester-vinyl acetate copolymer resin, vinyl acetate resin, ethylene-vinyl acetate copolymer resin, urethane resin, epoxy resin, synthetic rubber (SBR, NBR), and the like. Examples of solvent-based adhesive include epoxy resin, urethane resin, chloroprene resin, synthetic rubber (SBR, NBR), vinyl acetate resin, acrylic ester resin, and the like.

Among these, in the article of the present invention, a urethane-based resin adhesive having good water resistance strength is used as the adhesive for flocking fibers on the seal lip part. Specifically, a solvent-based one-liquid moisture-curing urethane-based resin is used

### [Fibers]

The fibers flocked on the seal lip part are made by cutting long fibers into short fibers.

Examples of fiber materials include nylon, rayon, polyester, and the like.

Nylon, which has sliding properties, is preferably used for automotive weather strips.

The fiber usually has a thickness of 0.6 to 3.0 denier, and a length of 0.6 to 1.5 mm.

### [Production of Article]

Although there is no particular restriction on the method for producing the article of the present invention, the article can be produced for example by first producing the main body part of the article (hereinafter, sometimes referred to as the “article main body”) without fibers flocked thereon, and then flocking the fibers on the article main body, as follows.

### <Production of Article Main Body>

(In the case where the main body and the seal lip part of the article main body are made of different materials.)

A known extrusion molding method is used to produce the article main body in which a main body part made of a molded body made of an olefin-based polymer or a coated molded body in which a metal core is coated with a coating material and a plurality of seal lip part made of the thermoplastic elastomer composition of the present invention are integrally molded.

In this case, the olefin-based polymer as the material of the main body part and the thermoplastic elastomer composition of the present invention as the material of the seal lip part are co-extruded into a mold of a desired shape, and the olefin-based polymer and the thermoplastic elastomer composition are integrally molded to obtain an article main body in which the main body part made of molded body made of the olefin-based polymer molded body and the seal lip part made of the thermoplastic elastomer composition of the present invention are integrally molded.

In addition, by inserting a metal sheet into the extruded portion of the olefin-based polymer during such extrusion molding, an article main body in which the main body part made of a coated molded body in which a metal core is coated with a coating material made of an olefin-based polymer and the seal lip part made of the thermoplastic elastomer composition of the present invention are integrally molded can be obtained.

(In the case where the article main body is a coated molded body in which a metal core is coated with a coating material.)

In this case, the thermoplastic elastomer composition of the present invention is used as the coating material.

In other words, the article main body can be obtained by extrusion molding the above mentioned metal sheet as the metal core and the thermoplastic elastomer composition of the present invention so that the metal sheet is coated with a coating layer made of the thermoplastic elastomer composition of the present invention.

### <Formation of Adhesive Layer and Flocking Process>

Adhesive is applied to the surface of the seal lip part of the article main body obtained as described above to form an adhesive layer. Then, the product is placed in a flocking machine and flocking process is carried out. If necessary, before applying the adhesive, a degreasing process may be performed as a supplementary surface treatment to wash away fingerprints, machine oil, and the like that inevitably adhere to the surface. The adhesive can be applied by any suitable means, such as a knife coater, a roll coater, a spray, a brush, a roller, or the like.

As a flocking process, an electrostatic processing method is preferably used, which has high productivity and high flocking strength. And the down method system is preferably used, in which the article main body coated with adhesive is placed on the lower electrode and electrically charged fibers are scattered from above to below to flock. After flocking, the product is made by heating and drying, and brushing to remove residual fibers.

### (Fiber-Flocked Seal Lip Member)

The fiber-flocked seal lip member of the present invention is obtained by flocking fibers to the molded body made of the above mentioned thermoplastic elastomer composition of the present invention with the urethane-based resin adhesive, and its size is approximately the same as that of the seal lip part of the article of the present invention.

The molded body of the fiber-flocked seal lip member can be produced by extrusion molding the thermoplastic elastomer composition of the present invention as described above.

Examples of the urethane-based resin adhesive and fibers include those exemplified in the description of the article of the present invention. Examples of the flocking method include those described above.

Usually, the fiber-flocked seal lip member of the present invention can be integrated with a separately molded coated molded body in which a metal core is coated with a coating material by fitting to form the article of the present invention.

In this case, the coated molded body in which a metal core is covered with a coating material may be one having the same configuration as the article main body of the article of the present invention described above, except that an integrating portion with the fiber-flocked seal lip member of the present invention is formed, and the producing method is also the same.

### [Automobile Weather Strip]

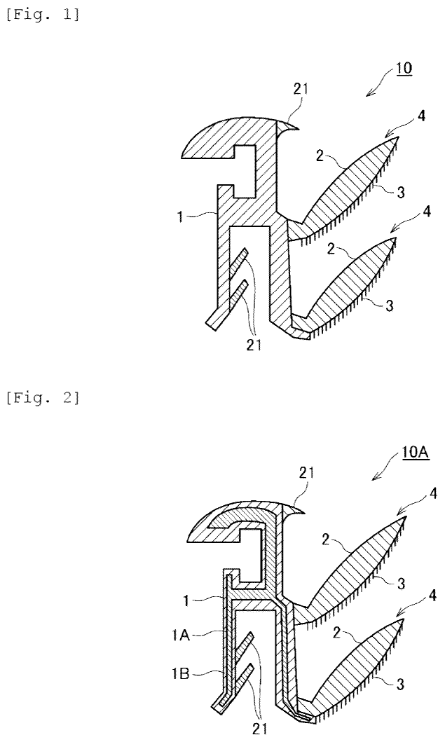

The article of the present invention will be described in more detail below with reference to FIGS. 1 to 4 showing an automobile weather strip, which is an automobile sealing part, and is an example of the article of the present invention.

In FIGS. 1 to 4, the same reference signs are used for members having the same functions.

In an automobile weather strip (10) of FIG. 1, a reference sign (1) denotes a main body part, (2) denotes a seal lip part, and (3) denotes a fiber flocked on the seal lip part (2) with an adhesive layer (not shown). A reference sign (21) denotes a seal lip part that does not require flocking of fibers. A reference sign (4) corresponds to a flocked seal lip part in which fibers (3) are flocked on the seal lip part (2).

The above mentioned olefin-based polymer is used for the main body part (1) of the above mentioned automobile weather strip (10), and the above mentioned thermoplastic elastomer composition of the present invention is used for the seal lip part (2). As described above, a solvent-based one-component moisture-curing urethane-based resin having good water resistance strength is preferably used for the adhesive layer. Nylon pile having a thickness of usually 0.6 to 3.0 denier and a length of usually 0.6 to 1.5 mm is preferably used for the fibers (3).

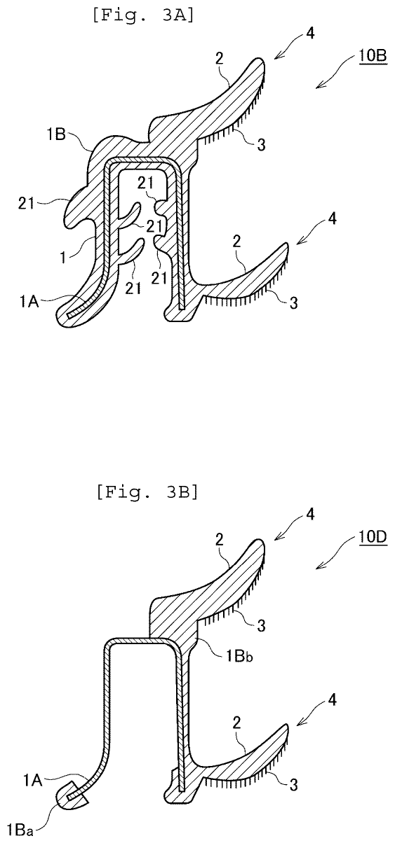

The automobile weather strip (10A) shown in FIG. 2 differs from the automobile weather strip (10) shown in FIG. 1 in that the main body part (1) is made of a coated molded body in which a metal core (1A) is coated with a coating material (1B), but otherwise has the same configuration.

The metal sheet and the olefin-based polymer described above are used for the metal core (1A) and the coating material (1B) respectively. The thermoplastic elastomer composition of the present invention is used for the seal lip parts (2) and (21).

As described above, a solvent-based one-component moisture-curing urethane-based resin having good water resistance strength is preferably used for the adhesive layer. For the fibers (3), nylon pile having a thickness of usually 0.6 to 3.0 denier and a length of usually 0.6 to 1.5 mm is preferably used.

The automobile weather strip (10B) shown in FIG. 3(a) is formed by integrally molding the main body part (1) in which the metal core (1A) is coated with the coating material (1B) and the seal lip parts (2) and (21). In this automobile weather strip (10B), the above mentioned metal sheet is used as the metal core (1A), and the thermoplastic elastomer composition of the present invention is used for the coating material (1B) of the main body part (1) and the seal lip parts (2) and (21).

As mentioned above, for the adhesive layer, a solvent-based one-component moisture-curing urethane-based resin having good water resistance strength is preferably used. For the fibers (3), nylon pile having a thickness of usually 0.6 to 3.0 denier and a length of usually 0.6 to 1.5 mm is preferably used.

The automobile weather strip (10D) shown in FIG. 3(b) differs from the automobile weather strip (10B) shown in FIG. 3(a) in that a part of the metal core (1A) (coated part (1Ba) and coated part (1Bb)) is made of the thermoplastic elastomer composition of the present invention, but otherwise has the similar configuration. In FIG. 3(b), members that perform the same functions as members in FIG. 3(a) are given the same reference signs.

In the automobile weather strip (10D), the coated part (1Ba) is the part that contacts the automobile body, and the coated part (1Bb) is the part that contacts the window glass.

This automobile weather strip (10D) can be produced by extrusion molding, like the automobile weather strip (10B).

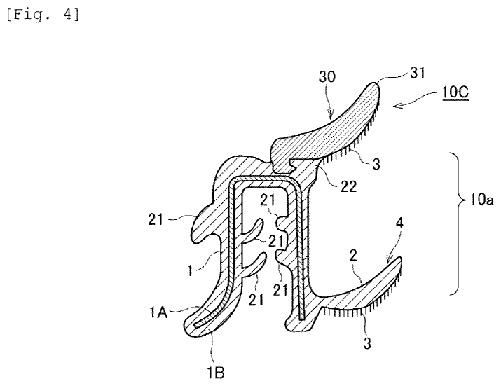

The automobile weather strip (10C) shown in FIG. 4 is configured by fitting the above mentioned fiber-flocked seal lip member (30) of the present invention to the fitting seal lip part (22) of the coating molded body (10a) in which the main body part (1) having the metal core (1A) and the coating material (1B) coating the metal core (1A) and the seal lip parts (2) and (21) are integrally molded. As described above, the fiber-flocked seal lip member (30) is the molded body (31) made of the thermoplastic elastomer composition of the present invention, to which fibers (3) are flocked via a urethane-based resin adhesive layer (not shown). The metal core (1A) and coating material (1B) are the same as those of the automobile weather strip (10B) shown in FIG. 3(a).

### EXAMPLES

Specific modes of the present invention will be described in detail by way of Examples. However, the present invention is not limited to the following Examples so long as they fall within the scope of the invention.

Various production conditions and the values of evaluation results in the following Examples have meanings as preferred upper or lower limits in the embodiments of the present invention, and preferred ranges may be ranges defined by any combination of the above-described upper or lower values and values in the following Examples or any combination of the values in the following Examples.

### [Raw Materials]

The raw materials used in the following Examples and Comparative Examples are as follows.

<Component (a)>
(a-1): Olefin-based thermoplastic elastomer/Trexprene® (registered trademark) QT70HG (a cross-linked thermoplastic elastomer having an olefin-based rubber (olefin-based elastomer) dispersed in a matrix of an olefin-based resin (propylene-based polymer)) manufactured by Mitsubishi Chemical Corporation
MFR: 3 g/10 min (measurement conditions: 230° C., load 49 N)
Duro hardness A: 67 (measurement conditions: IS07619)
(a-2): Ethylene-propylene-ethylidene norbornene copolymer rubber/Nordel® (registered trademark) IP4760P manufactured by Dow Chemical Company
Mooney viscosity (ML₁₊₄, 125° C.): 60
Propylene unit content: 27.5% by mass
Ethylene unit content: 67.5% by mass
Ethylidene norbornene unit content: 5.0% by mass
(a-3): Polypropylene/Novatec (registered trademark) FY6 manufactured by Japan Polypropylene Corporation
(a-4): Polypropylene/Novatec (registered trademark) FW4B manufactured by Japan Polypropylene Corporation
(a-5): Olefin-based thermoplastic elastomer/Tefabloc® (registered trademark) 5013 manufactured by Mitsubishi Chemical Corporation (a thermoplastic elastomer having an olefin-based rubber dispersed in a matrix of an olefin-based resin)
(a-6): Polypropylene/Novatec® (registered trademark) EG8B manufactured by Japan Polypropylene Corporation
(a-7): Polypropylene/Novatec® (registered trademark) MG03BD manufactured by Japan Polypropylene Corporation
(a-8): Styrene-ethylene-butylene-styrene copolymer (SEBS)/G1651 manufactured by Kraton Corporation
<Component (b)>
(b-1): Polytetramethylene ether glycol/PTMG250 manufactured by Mitsubishi Chemical Corporation
Number average molecular weight: 225
(b-2): Polytetramethylene ether glycol/PTMG2000 manufactured by Mitsubishi Chemical Corporation
Number average molecular weight: 2000
(b-3): Hydrogenated polybutadiene having hydroxyl groups at both ends/GI1000 manufactured by Nippon Soda Co., Ltd.
Number average molecular weight: 1500
(b-4): Hydrogenated polybutadiene having hydroxyl groups at both ends/GI3000 manufactured by Nippon Soda Co., Ltd.
Number average molecular weight: 3100
(b-5): Polyhydroxy polyolefin oligomer/Polytail (registered trademark) H manufactured by Mitsubishi Chemical Corporation
Number average molecular weight: 2800
<Component (c)>
(c-1): Modified polypropylene/UMEX 1001 manufactured by Sanyo Chemical Industries, Ltd.
Weight average molecular weight: 45,000
Acid value: 26 mg-KOH/mg
(c-2): Modified polypropylene

100 g of maleic anhydride and 130 g of organic peroxide (“Perbutyl O” manufactured by Nippon Oil & Fats Co., Ltd.) were added to 5 kg of commercially available homopolypropylene (polypropylene homopolymer) (density: 0.90 g/cm³, MFR (230° C., load 21.18 N): 0.6 g/10 min), and mixed. Obtained mixture was fed into a twin-screw extruder previously set at 230° C., melt mixed, and strand cut to obtain pellet-shaped modified polypropylene (c-2). The graft ratio of this modified polypropylene (c-2) (maleic anhydride content in the modified polypropylene) was 0.8% by mass, and the MFR, weight average molecular weight, and acid value were as follows.

MFR (180° C., load 2.16 kg): 52 g/10 min.
Weight average molecular weight: 120,000
Acid value: 9 mg-KOH/mg
(c-3): Acid-modified polypropylene

200 g of maleic anhydride and 40 g of organic peroxide (“Perbutyl I” manufactured by Nippon Oil & Fats Co., Ltd.) were added to 5 kg of commercially available homopolypropylene (polypropylene homopolymer) (density: 0.90 g/cm³, MFR (230° C., load 21.18 N): 0.6 g/10 min.) and mixed. Obtaine mixture was fed into a twin-screw extruder previously set at 230° C., melt mixed, and strand cut to obtain pellet-shaped modified polypropylene (c-3). The graft ratio of this modified polypropylene (c-3) was 1.2% by mass, and the MFR, weight average molecular weight, and acid value were as follows.

MER (180° C., load 21.18 N): 180 g/10 min.
Weight average molecular weight: 80,000
Acid value: 13 mg-KOH/mg
(c-4): Modified polypropylene

75 g of maleic anhydride and 80 g of organic peroxide (“Perbutyl O” manufactured by Nippon Oil & Fats Co., Ltd.) were added to 5 kg of commercially available random polypropylene (propylene-ethylene copolymer) (density: 0.87 g/cm³, MFR (230° C., load 21.18 N): 2.0 g/10 min), and mixed. Obtained mixture was fed into a twin-screw extruder previously set at 230° C., melt mixed, and strand cut to obtain pellet-shaped modified polypropylene (c-4). The graft ratio of this modified polypropylene (c-4) was 0.6% by mass, and the MFR, weight average molecular weight, and acid value were as follows.

MFR (180° C., load 21.18 N): 11 g/10 min.
Weight average molecular weight: 110,000
Acid value: 7 mg-KOH/mg
<Component (d)>
(d): Paraffinic oil/DIANA (registered trademark) Process Oil PW-90 manufactured by Idemitsu Kosan Co., Ltd.
Kinematic viscosity at 40° C.: 95.54 cSt
Flash point: 272° C.
<Component (e)>
(e): Mixture of 40% by mass of 2,5-dimethyl-2,5-di(t-butylperoxy) hexane and 60% by mass of calcium carbonate/TRIGONOX (registered trademark) 101-40C manufactured by Kayaku Nouryon Corporation
<Component (f)>
(f): Divinylbenzene (hereinafter referred to as DVB)/DVB-570 (purity 57%) manufactured by Nippon Steel Chemical & Material Co., Ltd.
<Component (g)>
(g): Dioctyltin dilaurate (hereinafter referred to as DOTDL)/TVS8501 manufactured by Nitto Kasei Co., Ltd.

### [Evaluation Methods]

Evaluation methods for the thermoplastic elastomer compositions in the following Examples and Comparative Examples are as below.

### <Adhesive Strength>

The thermoplastic elastomer composition was molded into a sheet having a thickness of 2 mm at 190° C. using a press molding machine (hydraulic jack type heating and cooling press 200×200 mm, manufactured by Toyo Seiki Seisaku-sho, Ltd.). A urethane-based resin adhesive Sangrip TKS-63 (components: urethane prepolymer, toluene, butyl acetate, methyl ethyl ketone, 4,4-diphenylmethane diisocyanate) manufactured by Sanwa Koubunshi Industries Co., Ltd., was applied to the surface of the molded sheet with a bar coater to a thickness of approximately 10 μm, and while the adhesive was still wet, polyester tape (Polyco tape manufactured by Okuda Sangyo Co., Ltd., width of 17 mm) was placed over the adhesive, taking care not to trap air bubbles between the polyester tape and the adhesive. The sheet was then dried in an oven at 80° C. for 30 minutes and then left to stand at room temperature for 24 hours.

For the obtained test pieces, the adhesive strength between the tape and the sheet was measured by a 180 degree peel test method (test speed 50 mm/min, peel distance approximately 50 mm, maximum test force measured) using an Autograph AG2000 manufactured by Shimadzu Corporation, with reference to the standard ISO8510-2:1990.

The adhesive property between the thermoplastic elastomer composition sheet and the urethane-based resin was evaluated from this peel strength.

In addition, the peeled surface of the test piece after measuring the peel strength between the thermoplastic elastomer composition sheet and the urethane-based resin was observed as the peeling mode.

When peeling occurred near the interface between the thermoplastic elastomer composition sheet and the urethane-based resin adhesive layer, it was evaluated as interfacial peeling (referred to as “interface” in the Table below).

When the thermoplastic elastomer composition sheet was destroyed, it was evaluated as material destruction (referred to as “material destruction” in the Table below).

In this evaluation, material destruction means that the adhesion between the thermoplastic elastomer composition and the urethane-based resin is stronger than in the case of interfacial peeling.

### <Duro a Hardness>

Thermoplastic elastomer composition was molded into a sheet having a thickness of 2 mm at 190° C. using a press molding machine (hydraulic jack type heating and cooling press 200×200 mm, manufactured by Toyo Seiki Seisaku-sho, Ltd.). Using this sheet, duro A hardness was measured in accordance with JIS K6253.

From the viewpoint of flexibility, duro A hardness is preferably in the range of 10 to 99.

### <Confirmation of Die Drool Generation>

Using a single-screw extruder (full flight screw with L/D=22, (compression ratio)=2.0) having a diameter of 20 mm manufactured by Toyo Seiki Seisaku-sho, Ltd. and a sheet-shaped die having a width of 40 mm and a thickness of 0.5 mm, an extrusion molding was carried out for 10 minutes under the molding temperature conditions of below the hopper temperature of 180° C., cylinder temperature of 200° C., die temperature of 200° C., and a screw rotation speed of 60 rpm. After that, the die drool adhering to the die and the molded product was visually confirmed and evaluated according to the following criteria.

∘: Almost no die drool was generated on either the die or the molded product.
x: A large amount of die drool was generated on the die and the molded product.

### Examples/Comparative Examples

### Example 1

100 parts by mass of the component (a-1), 0.2 parts by mass of the component (b-1) and 5.3 parts by mass of the component (c-1) were added to a small kneader (Labo Plastomill 20C-200, Mixer R-60H, manufactured by Toyo Seiki Seisaku-sho, Ltd.) under the condition of a temperature setting of 160° C., and the mixture was homogenized at a rotor rotation speed of 20 rpm. The mixture was then heated to a temperature range of 180 to 210° C. and kneaded for 5 minutes at a rotor speed of 100 rpm to produce a crosslinked thermoplastic elastomer composition. The obtained crosslinked thermoplastic elastomer composition was subjected to the above mentioned evaluations, and the results are shown in Table-1A.

### Examples 2 to 12 and Comparative Examples 1 to 5

Each crosslinked thermoplastic elastomer composition was obtained in the same manner as in Example 1, except that the composition was as shown in Tables-1A and -1B. Each crosslinked thermoplastic elastomer composition thus obtained was evaluated in the same manner as in Example 1. The evaluation results are shown in Tables-1A and -1B.

### Example 13

Using the same kneading equipment as in Example 1, 39 parts by mass of the component (a-2), 10 parts by mass of the component (a-3), 6 parts by mass of the component (a-4), 10 parts by mass of the component (a-5), 4.5 parts by mass of the component (c-4), and 0.1 parts by mass of the component (b-1) were added under the conditions of a temperature setting of 160° C. and a rotor rotation speed of 20 rpm, and then 35 parts by mass of the component (d) was slowly added and homogenized. After that, 0.4 parts by mass of the component (e) and 0.3 parts by mass of the component (f) were added, and the mixture was heated to a temperature range of 180 to 210° C. and kneaded for 5 minutes under the condition of a rotor rotation speed of 100 rpm, to obtain a crosslinked thermoplastic elastomer composition. The obtained crosslinked thermoplastic elastomer composition was evaluated in the same manner as in Example 1, and the results are shown in Table-2.

### Comparative Examples 6 to 10

Each crosslinked thermoplastic elastomer composition was obtained in the same manner as in Example 13, except that the composition was as shown in Table-2. Each crosslinked thermoplastic elastomer composition obtained was evaluated in the same manner as in Example 13. The evaluation results are shown in Table-2.

### Example 14

39 parts by mass of the component (a-2), 12 parts by mass of the component (a-6), 8 parts by mass of the component (a-8), 8.7 parts by mass of the component (c-3), 0.2 parts by mass of the component (b-1), 41 parts by mass of the component (d), 0.52 parts by mass of the component (e), and 0.48 parts by mass of the component (f) were dynamically heat-treated by melt kneading at 110 to 220° C. using a co-rotation twin-screw extruder (“KTX44” manufactured by Kobe Steel, Ltd., L/D=41, number of cylinder blocks=11). After the heat treatment, the product was extruded from a die into a strand shape and cut to obtain pellets of a crosslinked thermoplastic elastomer composition. The obtained crosslinked thermoplastic elastomer composition was subjected to the above mentioned evaluations, and the results are shown in Table-3.

### Examples 15 to 16 and Comparative Examples 11 to 12

Each crosslinked thermoplastic elastomer composition was obtained in the same manner as in Example 14, except that the composition was as shown in Table-3. Each crosslinked thermoplastic elastomer composition thus obtained was evaluated in the same manner as in Example 14. The evaluation results are shown in Table-3.

| | | | | TABLE-1A | | | | | | |
|---|---|---|---|---|---|---|---|---|---|---|
| | | | | Example | | | | | | |
| | | | | 1 | 2 | 3 | 4 | 5 | 6 | 7 |
| Raw | Component | a-1 | Parts | 100 | 100 | 100 | 100 | 100 | 100 | 100 |
| Material | (a) | | by Mass | | | | | | | |
| Blend | Component | c-1 | Parts | 5.3 | 5.3 | | | | | |
| | (B) | | by Mass | | | | | | | |
| | | c-2 | Parts | | | 5.3 | | | | |
| | | | by Mass | | | | | | | |
| | | c-3 | Parts | | | | 5.3 | 5.3 | 5.3 | 5.3 |
| | | | by Mass | | | | | | | |
| | | b-1 | Parts | 0.2 | 0.5 | 0.1 | 0.1 | 0.2 | 0.5 | 2.1 |
| | | | by Mass | | | | | | | |
| | | b-2 | Parts | | | | | | | |
| | | | by Mass | | | | | | | |
| | | b-3 | Parts | | | | | | | |
| | | | by Mass | | | | | | | |
| | | b-4 | Parts | | | | | | | |
| | | | by Mass | | | | | | | |
| | | b-5 | Parts | | | | | | | |
| | | | by Mass | | | | | | | |
| | Component | g | Parts | | | | | | | |
| | (g) | | by Mass | | | | | | | |

| | | | | | | | | | |
|---|---|---|---|---|---|---|---|---|---|
| Evaluation | Adhesive | N/17 | 18 | 96 | 40 | 79 | 20 | 53 | 48 |
| Results | Strength | mm | | | | | | | |
| | Peeling | | Inter- | Material | Material | Material | Material | Material | Material |
| | Mode | | face | Destruction | Destruction | Destruction | Destruction | Destruction | Destruction |
| | Duro A | | 68 | 68 | 68 | 67 | 68 | 68 | 68 |
| | Hardness | | | | | | | | |

| | | | | Example | | | | |
|---|---|---|---|---|---|---|---|---|
| | | | | 8 | 9 | 10 | 11 | 12 |
| Raw | Component | a-1 | Parts | 100 | 100 | 100 | 100 | 100 |
| Material | (a) | | by Mass | | | | | |
| Blend | Component | c-1 | Parts | | | | | |
| | (B) | | by Mass | | | | | |
| | | c-2 | Parts | | | | | |
| | | | by Mass | | | | | |
| | | c-3 | Parts | 5.3 | 5.3 | 5.3 | 5.3 | 5.3 |
| | | | by Mass | | | | | |
| | | b-1 | Parts | 3.9 | | | | |
| | | | by Mass | | | | | |
| | | b-2 | Parts | | 3.9 | | | |
| | | | by Mass | | | | | |
| | | b-3 | Parts | | | 3.9 | | |
| | | | by Mass | | | | | |
| | | b-4 | Parts | | | | 3.9 | |
| | | | by Mass | | | | | |
| | | b-5 | Parts | | | | | 3.9 |
| | | | by Mass | | | | | |
| | Component | g | Parts | | | | | |
| | (g) | | by Mass | | | | | |

| | | | | | | | |
|---|---|---|---|---|---|---|---|
| Evaluation | Adhesive | N/17 | 78 | 88 | 76 | 44 | 76 |
| Results | Strength | mm | | | | | |
| | Peeling | | Material | Material | Material | Material | Material |
| | Mode | | Destruction | Destruction | Destruction | Destruction | Destruction |
| | Duro A | | 68 | 69 | 69 | 69 | 69 |
| | Hardness | | | | | | |

TABLE 1B

| | | | | Comparative Example | | | | |
|---|---|---|---|---|---|---|---|---|
| | | | | 1 | 2 | 3 | 4 | 5 |
| Raw | Component | a-1 | Parts | 100 | 100 | 100 | 100 | 100 |
| Material | (a) | | by Mass | | | | | |
| Blend | Component | c-1 | Parts | | | | | |
| | (B) | | by Mass | | | | | |
| | | c-2 | Parts | | | | | |
| | | | by Mass | | | | | |
| | | c-3 | Parts | | 5.3 | | | |
| | | | by Mass | | | | | |
| | | b-1 | Parts | | | 3.9 | | |
| | | | by Mass | | | | | |
| | | b-2 | Parts | | | | | |
| | | | by Mass | | | | | |
| | | b-3 | Parts | | | | | |
| | | | by Mass | | | | | |
| | | b-4 | Parts | | | | | |
| | | | by Mass | | | | | |
| | | b-5 | Parts | | | | 3.9 | 3.9 |
| | | | by Mass | | | | | |
| | Component | g | Parts | | | | | 0.4 |
| | (g) | | by Mass | | | | | |

| | | | | | | | |
|---|---|---|---|---|---|---|---|
| Evaluation | Adhesive | N/17 | 0 | 5 | 0 | 0 | 5 |
| Results | Strength | mm | | | | | |
| | Peeling | | Inter- | Inter- | Inter- | Inter- | Inter- |
| | Mode | | face | face | face | face | face |
| | Duro A | | 67 | 70 | 66 | 66 | 66 |
| | Hardness | | | | | | |

TABLE 2

| | | | | Example | Comparative Example | | | | |
|---|---|---|---|---|---|---|---|---|---|
| | | | | 13 | 6 | 7 | 8 | 9 | 10 |
| Raw | Component | a-2 | Parts | 39 | 39 | 39 | 39 | 39 | 39 |
| Material | (a) | | by Mass | | | | | | |
| Blend | | a-3 | Parts | 10 | 10 | 10 | 10 | 10 | 10 |
| | | | by Mass | | | | | | |
| | | a-4 | Parts | 6 | 6 | 6 | 6 | 6 | 6 |
| | | | by Mass | | | | | | |
| | | a-5 | Parts | 10 | 10 | 10 | 10 | 10 | 10 |
| | | | by Mass | | | | | | |
| | Component | c-4 | Parts | 4.5 | | 4.5 | | | |
| | (B) | | by Mass | | | | | | |
| | | b-1 | Parts | 0.1 | | | 0.1 | | |
| | | | by Mass | | | | | | |
| | | b-5 | Parts | | | | | 4.5 | 4.5 |
| | | | by Mass | | | | | | |
| | Component | d | Parts | 35 | 35 | 35 | 35 | 35 | 35 |
| | (d) | | by Mass | | | | | | |
| | Component(e) | e | Parts | 0.4 | 0.4 | 0.4 | 0.4 | 0.4 | 0.4 |
| | | | by Mass | | | | | | |
| | Component | g | Parts | | | | | | 0.4 |
| | (g) | | by Mass | | | | | | |
| | Component | f | Parts | 0.3 | 0.3 | 0.3 | 0.3 | 0.3 | 0.3 |
| | (f) | | by Mass | | | | | | |

| | | | | | | | | |
|---|---|---|---|---|---|---|---|---|
| Evaluation | Adhesive | N/17 | 14 | 0 | 3 | 1 | 1 | 6 |
| Results | Strength | mm | | | | | | |
| | Peeling | | Inter- | Inter- | Inter- | Inter- | Inter- | Inter- |
| | Mode | | face | face | face | face | face | face |
| | Duro A | | 69 | 70 | 68 | 70 | 69 | 69 |
| | Hardness | | | | | | | |

TABLE 3

| | | | | Example | | | Comparative Example | |
|---|---|---|---|---|---|---|---|---|
| | | | | 14 | 15 | 16 | 11 | 12 |
| Raw | Component | a-2 | Parts | 39 | 39 | 39 | 35.5 | 46 |
| Material | (a) | | by Mass | | | | | |
| Blend | | a-6 | Parts | 12 | 12 | 7 | 19 | 19.5 |
| | | | by Mass | | | | | |
| | | a-7 | Parts | | | 5 | | |
| | | | by Mass | | | | | |
| | | a-8 | Parts | 8 | 8 | 8 | 7.5 | |
| | | | by Mass | | | | | |
| | Component | c-3 | Parts | 8.7 | 8.7 | 8.7 | | |
| | (B) | | by Mass | | | | | |
| | | b-1 | Parts | 0.2 | 3.9 | 3.9 | | |
| | | | by Mass | | | | | |
| | Component | d | Parts | 41 | 41 | 41 | 38 | 34.5 |
| | (d) | | by Mass | | | | | |
| | Component | e | Parts | 0.52 | 0.52 | 0.52 | 0.48 | 0.48 |
| | (e) | | by Mass | | | | | |
| | Component | f | Parts | 0.48 | 0.48 | 0.48 | 0.44 | 0.44 |
| | (f) | | by Mass | | | | | |

| | | | | | | | |
|---|---|---|---|---|---|---|---|
| Evaluation | Adhesive | N/17 | 24 | 49 | 45 | 1 | 1 |
| Results | Strength | mm | | | | | |
| | Peeling | | Material | Material | Material | Inter- | Inter- |
| | Mode | | Destruction | Destruction | Destruction | face | face |
| | Duro A | | 69 | 67 | 68 | 67 | 68 |
| | Hardness | | | | | | |
| | Die Drool | | ◯ | ◯ | ◯ | ◯ | X |
| | Generation | | | | | | |

### <Evaluation Results>

As shown in Tables-1A and -1B, it can be seen that Examples 1 to 12 had superior adhesiveness compared to the Comparative Examples.

Also, as shown in Table-2, similar to Tables-1A and -1B, it can be seen that Example 13 had superior adhesiveness compared to the Comparative Examples.

Also, as shown in Table-3, similar to Tables-1A, -1B, and Table-2, it can be seen that Examples 14 to 16 had superior adhesiveness compared to the Comparative Example. Moreover, Examples 14 to 16 had excellent extrusion moldability without the generation of die drool during extrusion molding.

### INDUSTRIAL APPLICABILITY

The article of the present invention is suitably applied to any of a variety of articles having a plurality of fiber-flocked seal lip parts with flocked fibers, but is particularly useful industrially as an automobile weather strip.

The crosslinked thermoplastic elastomer composition of the present invention has superior adhesive strength with adhesive, different resins, paint, metal, or glass. For this reason, the crosslinked thermoplastic elastomer composition of the present invention can be used in a wide range of fields, such as civil engineering and building material parts (waterstop materials, joint materials, window frames), sporting goods, industrial parts (multi-layer hose tubes), home appliance parts (multi-layer hoses), medical parts (medical multi-layer containers), food parts (multi-layer packaging films, containers, bottles, decorative packaging, labels), electric wires, miscellaneous goods, and automobile parts (weather strips, ceiling materials, interior sheets, bumper moldings, side moldings, air spoilers, hoses, armrests, door trims, console lids, mats).

Although the present invention has been described in detail with reference to specific embodiments, it is apparent to a person skilled in the art that various alterations and modifications can be made therein without departing from the spirit and scope of the present invention.

The present application is based on Japanese Patent Application No. 2022-140092 filed on Sep. 2, 2022, which is herein incorporated in its entirety by reference.

### REFERENCE SIGNS LIST

1 Main body part
1A Metal core
1B Coating material
2 Seal lip part
3 Fiber
4 Flocked seal lip part
10, 10A, 10B, 10C, 10D Automobile weather strip
21 Seal lip part
22 Fitting seal lip part
30 Fiber-flocked seal lip member

1. An article having a plurality of seal lip parts,
wherein at least one of the plurality of seal lip parts includes a thermoplastic elastomer composition comprising a thermoplastic elastomer and a polyolefin having a repeating unit represented by the following formula (I), and
at least one of the plurality of seal lip parts comprises a flocked seal lip part including fibers flocked with a urethane-based resin adhesive, 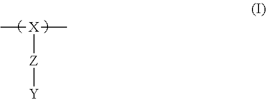
in formula (I),
X is a polyolefin main chain,
Z is an organic group derived from an unsaturated carboxylic acid or its derivative, and
Y is an organic group derived from a polyalkylene ether glycol, or an organic group derived from a polyhydroxy polyolefin.

2. The article according to claim 1, wherein the plurality of seal lip parts comprises the thermoplastic elastomer composition.

3. The article according to claim 1, wherein the article has a main body part,
the main body part including a molded body comprising an olefin-based polymer, or a coated molded body having a metal core and a coating material coating the metal core, and
the main body part and the plurality of seal lip parts are integrally molded.

4. The article according to claim 3, wherein the main body part comprises the coated molded body having a metal core and a coating material coating the metal core.

5. The article according to claim 1, wherein the thermoplastic elastomer including an elastomer-based resin composition comprising an olefin-based elastomer and a propylene-based polymer.

6. The article according to claim 5, wherein the olefin-based elastomer comprises an ethylene-propylene-based copolymer elastomer having a Mooney viscosity ML₁₊₄ (125° C.) of 30 to 75.

7. The article according to claim 5, wherein the propylene-based polymer has a melt flow rate (MFR) of 0.1 to 35 g/10 min at 230° C. and a load of 21.18 N.

8. The article according to claim 5, wherein the thermoplastic elastomer includes the olefin-based elastomer in an amount of 70 to 90% by mass and the propylene-based polymer in an amount of 10 to 30% by mass based on 100% by mass of a total of the olefin-based elastomer and the propylene-based polymer.

9. The article according to claim 1, wherein the thermoplastic elastomer composition contains 1 to 30 parts by mass of the polyolefin having a repeating unit represented by the following formula (I) based on 100 parts by mass of the thermoplastic elastomer.

10. The article according to claim 5, wherein the elastomer-based resin composition further comprises a styrene-based elastomer.

11. The article according to claim 10, wherein the styrene-based elastomer comprises at least one selected from the group consisting of a hydrogenated styrene-butadiene block copolymer and a hydrogenated styrene-isoprene block copolymer.

12. The article according to claim 10, wherein a content of the styrene-based elastomer is 18 by mass or more and less than 50% by mass based on 100% by mass of a total of the olefin-based elastomer and the styrene-based elastomer.

13. The article according to claim 1, wherein the thermoplastic elastomer composition comprises a crosslinked thermoplastic elastomer composition.

14. The article according to claim 1, wherein the article comprises an automobile seal part.

15. A fiber-flocked seal lip member comprising a molded body and fibers flocked to the molded body with a urethane-based resin adhesive,
wherein the molded body includes a thermoplastic elastomer composition comprising: a thermoplastic elastomer; and a polyolefin having a repeating unit represented by the following formula (I), 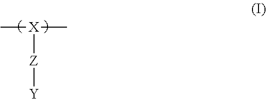
in formula (I),
X is a polyolefin main chain,
Z is an organic group derived from an unsaturated carboxylic acid or its derivative, and
Y is an organic group derived from a polyalkylene ether glycol, or an organic group derived from a polyhydroxy polyolefin.

16. An article comprising:
a coated molded body; and
the fiber-flocked seal lip member according to claim fitted to the coated molded body,
wherein the coated molded body comprises a metal core and a coating material coating the metal core.

17. The article according to claim 16, wherein the article comprises an automobile seal part.

18. A crosslinked thermoplastic elastomer composition comprising: a thermoplastic elastomer; and a polyolefin having a repeating unit represented by the following formula (I), 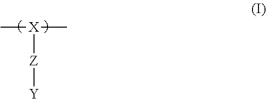
in formula (I),
X is a polyolefin main chain,
Z is an organic group derived from an unsaturated carboxylic acid or its derivative, and
Y is an organic group derived from a polyalkylene ether glycol, or an organic group derived from a polyhydroxy polyolefin.

19. The crosslinked thermoplastic elastomer composition according to claim 18, wherein the polyolefin comprises an esterification reaction product of a modified polyolefin modified with an unsaturated carboxylic acid and/or its derivative, and a polyalkylene ether glycol and/or a polyhydroxy polyolefin.

20. The crosslinked thermoplastic elastomer composition according to claim 18, wherein the thermoplastic elastomer comprises an olefin-based elastomer.

21. The crosslinked thermoplastic elastomer composition according to claim 20, wherein the thermoplastic elastomer further comprises a styrene-based elastomer.

22. The crosslinked thermoplastic elastomer composition according to claim 20, wherein the olefin-based elastomer comprises an ethylene-propylene-based copolymer elastomer having a Mooney viscosity ML₁₊₄ (125° C.) of 30 to 75.

23. A method for producing the crosslinked thermoplastic elastomer composition according to claim 18, comprising reacting a mixture containing a crosslinkable thermoplastic elastomer, a polyalkylene ether glycol and/or a polyhydroxy polyolefin, and a modified polyolefin modified with an unsaturated carboxylic acid and/or its derivative, such that a part of the crosslinkable thermoplastic elastomer is crosslinked.

24. The method for producing a crosslinked thermoplastic elastomer composition according to claim 23, wherein the mixture comprises 0.1 to 10 parts by mass of the polyalkylene ether glycol and/or a polyhydroxy polyolefin and 1 to 20 parts by mass of the modified polyolefin based on 100 parts by mass of the crosslinkable thermoplastic elastomer.

25. The method for producing a crosslinked thermoplastic elastomer composition according to claim 23, wherein the mixture further comprises a hydrocarbon-based rubber softener.

26. The method for producing a crosslinked thermoplastic elastomer composition according to claim 25, wherein the mixture comprises 0.1 to 10 parts by mass of the polyalkylene ether glycol and/or a polyhydroxy polyolefin and 1 to 20 parts by mass of the modified polyolefin based on the total of 100 parts by mass of the crosslinkable thermoplastic elastomer and the hydrocarbon-based rubber softener.

27. The method for producing a crosslinked thermoplastic elastomer composition according to claim 23, wherein a number average molecular weight of the polyalkylene ether glycol and/or polyhydroxy polyolefin is 200 to 5000.
